(19) United States
(12) Patent Application Publication
(10) Pub. No.: US 2025/0269693 A1
(43) Pub. Date: Aug. 28, 2025

(54) TRAILER ELECTRICAL CONNECTOR HAVING INTEGRATED MAGNET

(71) Applicant: Krystina McNamara, West Haven, UT (US)

(72) Inventor: Krystina McNamara, West Haven, UT (US)

(21) Appl. No.: 18/815,465

(22) Filed: Aug. 26, 2024

Related U.S. Application Data
(60) Provisional application No. 63/557,307, filed on Feb. 23, 2024.

(51) Int. Cl. B60D 1/64; H01R 13/633; H01R 24/20

(52) U.S. Cl. CPC B60D 1/64; H01R 13/6335; H01R 24/20

(57) ABSTRACT

A trailer electrical connector includes a housing that has a front section, defining an electrical interface end of the housing, and a rear section, defining a cord engagement end of the housing and extending from the front section. The electrical interface end of the housing is smaller than the cord engagement end of the housing. The rear section includes a tapering portion. The housing also includes a receptacle formed in an external surface of the tapering portion of the rear section of the housing. The trailer electrical connector also includes a magnet, within and attached to the receptacle such that the magnet does not move relative to the housing, and includes a plurality of electrical connections located at the electrical interface end of the housing. The trailer electrical connector additionally includes a cord attached to the cord engagement end of the housing.

### FIELD

The present disclosure relates generally to vehicle trailers and more particularly to vehicle trailer connectors.

### BACKGROUND

Vehicle trailers are becoming increasingly popular among consumers. Vehicle trailers can come in various shapes and sizes for varying purposes. Generally, trailers have a frame and at least two wheels rotatably fixed to the frame. The frame is intended to support and facilitate hauling of an object or objects by a vehicle. Some vehicle trailers are relatively small and designed to haul a small about of materials, such as camping gear or a few moving boxes, or are a relatively small travel trailer. Alternatively, medium trailers are often used for recreational purposes and may be adapted to hold larger objects, such as a set of ATVs, dirt bikes, a small fishing boat, or may be a medium-sized enclosed trailer or travel trailer. There are also large trailers adapted for transporting larger loads, such as jet ski boats, or configured to be a large-sized enclosed trailer or travel trailer.

Vehicle trailers can be attached to a wide variety of vehicles, so long as the vehicle has a proper towing capacity. For added safety during travel, and regulated by governmental departments of transportation, vehicle trailers include a wiring harness and corresponding trailer lights. The wiring harness includes an electrical connector that is plugged into a corresponding electrical socket in a towing vehicle. Electrical connectivity between the vehicle trailer and the towing vehicle enables activation of the trailer lights by the towing vehicle. The trailer lights include turn signals, brake lights, and reverse lights, which mimic or match operation of the corresponding lights of the towing vehicle.

When not in use, the wiring harness (including the electrical connector) of the vehicle trailer is susceptible to damage. For example, the wiring harness may be damaged by excessive or tight winding of the harness around the frame of the vehicle trailer. Alternatively, damage may be caused by the wiring harness being run over or impacted by vehicles, objects, or people. For example, the wiring harness may be stepped on or driven over by users not knowing the cord is on the ground. Severe damage may also be caused when the wiring harness is on the ground in contact with latent water on the ground, which can corrode the metallic materials of the wiring harness. Safely, efficiently, and repeatedly securing and storing wiring harnesses, when disconnected from the towing vehicle, can be difficult.

### SUMMARY

The subject matter of the present disclosure has been developed in response to the present state of the art, and in particular, in response to the problems and needs in the art that have not yet been fully solved by currently available trailer wiring harnesses and storage methods. From the foregoing discussion, it should be apparent that a need exists for an apparatus, a system, and a method that more effectively make and store an electrical connector of a trailer wiring harness. Beneficially, such an apparatus, system, and method would reduce damage to the cords and housing of the trailer wiring harness. Accordingly, the subject matter of the present disclosure has been developed to provide a trailer electrical connector with an integrated magnet that may overcome many or all of the above-discussed or other shortcomings in the art.

Disclosed herein is a trailer electrical connector. The trailer electrical connector includes a housing. The housing includes a front section defining an electrical interface end of the housing. The housing also includes a rear section defining a cord engagement end of the housing and extending from the front section. The electrical interface end of the housing is smaller than cord engagement end of the housing. The rear section includes a tapering portion that tapers away from the front section toward the cord engagement end. The housing also includes a receptacle formed in an external surface of the tapering portion of the rear section of the housing. The trailer electrical connector also includes a magnet within and attached to the receptacle such that the magnet does not move relative to the housing. The trailer electrical connector further includes a plurality of electrical connections located at the electrical interface end of the housing. The trailer electrical connector additionally includes a cord attached to the cord engagement end of the housing. The preceding subject matter of this paragraph characterizes example 1 of the present disclosure.

The receptacle and the magnet have a circular cross-sectional shape. The preceding subject matter of this paragraph characterizes example 2 of the present disclosure, wherein example 2 also includes the subject matter according to example 1, above.

The housing further includes a guide tab protruding from the external surface of the tapering portion of the rear section of the housing and from an external surface of the front section of the housing. The preceding subject matter of this paragraph characterizes example 3 of the present disclosure, wherein example 3 also includes the subject matter according to any of examples 1-2, above.

The electrical interface end is adapted to receive a 7-prong vehicle electrical connector. The preceding subject matter of this paragraph characterizes example 4 of the present disclosure, wherein example 4 also includes the subject matter according to any of examples 1-3, above.

The electrical interface end is adapted to receive one of a 4-prong vehicle electrical connector or a 5-prong vehicle electrical connector. The preceding subject matter of this paragraph characterizes example 5 of the present disclosure, wherein example 5 also includes the subject matter according to any of examples 1-4, above.

A height of the receptacle, at a location closest to the electrical interface end of the housing, is less than a height of the receptacle, at a location closest to the cord engagement end of the housing. The preceding subject matter of this paragraph characterizes example 6 of the present disclosure, wherein example 6 also includes the subject matter according to any of examples 1-5, above.

The housing further includes at least two handles located on opposing sides of the housing. The preceding subject matter of this paragraph characterizes example 7 of the present disclosure, wherein example 7 also includes the subject matter according to any of examples 1-6, above.

The at least two handles protrude perpendicular to a central axis and are parallel to a mounting surface of the magnet. The preceding subject matter of this paragraph characterizes example 8 of the present disclosure, wherein example 8 also includes the subject matter according to example 7, above.

A portion of each one of the at least two handles overlaps with another portion of the corresponding one of the at least two handles along a plane perpendicular to a central axis of the trailer electrical connector. The preceding subject matter of this paragraph characterizes example 9 of the present disclosure, wherein example 9 also includes the subject matter according to example 8, above.

The magnet includes a mounting surface that is planar and is proud relative to the receptacle. The preceding subject matter of this paragraph characterizes example 10 of the present disclosure, wherein example 10 also includes the subject matter according to any of examples 1-9, above.

The receptacle includes an outer rim. The outer rim is substantially flush with an exterior surface of the front section. The preceding subject matter of this paragraph characterizes example 11 of the present disclosure, wherein example 11 also includes the subject matter according to any of examples 1-10, above.

The housing further includes at least two handles located on opposing sides of the housing protruding from the tapering rear portion of the housing. The preceding subject matter of this paragraph characterizes example 12 of the present disclosure, wherein example 12 also includes the subject matter according to example 11, above.

The handles lie within a first plane that is parallel to a planar mounting surface of the magnet. The preceding subject matter of this paragraph characterizes example 13 of the present disclosure, wherein example 13 also includes the subject matter according to example 12, above.

The housing further includes at least one set of ridges along the body of the housing. The preceding subject matter of this paragraph characterizes example 14 of the present disclosure, wherein example 14 also includes the subject matter according to any of examples 1-13, above.

The magnet includes a planar exterior surface flush with the receptacle. The preceding subject matter of this paragraph characterizes example 15 of the present disclosure, wherein example 15 also includes the subject matter according to any of examples 1-14, above.

The magnet is selectively removable from the receptacle. Any one of a plurality of trailer engagement couplings is interchangeable with the magnet and selectively attachable to and within the receptacle. The preceding subject matter of this paragraph characterizes example 16 of the present disclosure, wherein example 16 also includes the subject matter according to any of examples 1-15, above.

Further disclosed herein is a method of storing a trailer electrical connector. The method of storing a trailer electrical connector includes disconnecting a trailer electrical connector of a trailer from a vehicle electrical connector of a vehicle and selectively magnetically attaching a magnet of the trailer electrical connector to a connector portion of the trailer. The preceding subject matter of this paragraph characterizes example 17 of the present disclosure.

The connector portion is made of metal. The preceding subject matter of this paragraph characterizes example 18 of the present disclosure, wherein example 18 also includes the subject matter according to example 17, above.

The connector portion includes a magnet having a polarity that is opposite the polarity of the magnet of the trailer electrical connector. The preceding subject matter of this paragraph characterizes example 19 of the present disclosure, wherein example 19 also includes the subject matter according to any of examples 17-18, above.

Additionally disclosed herein is an electrical connector system including a vehicle electrical connector. The electrical connector system also includes a trailer electrical connector. The trailer electrical connector includes a housing including a front section defining an electrical interface end of the housing. The housing also includes a rear section defining a cord engagement end of the housing and extending from the front section. The electrical interface end of the housing is smaller than cord engagement end of the housing. The rear section includes a tapering portion that tapers away from the front section toward the cord engagement end. The housing further includes a receptacle formed in an external surface of the tapering portion of the rear section of the housing. The trailer electrical connector also includes a magnet within and attached to the receptacle such that the magnet does not move relative to the housing. The trailer electrical connector further includes a plurality of electrical connections located at the electrical interface end of the housing. The trailer electrical connector additionally includes a cord attached to the cord engagement end of the housing. The preceding subject matter of this paragraph characterizes example 20 of the present disclosure.

Reference throughout this specification to features, advantages, or similar language does not imply that all of the features and advantages that may be realized with the subject matter of the present disclosure should be or are in any single embodiment of the subject matter. Rather, language referring to the features and advantages is understood to mean that a specific feature, advantage, or characteristic described in connection with an embodiment is included in at least one embodiment of the subject matter of the present disclosure. Thus, discussion of the features and advantages, and similar language, throughout this specification may, but do not necessarily, refer to the same embodiment.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter of the present disclosure will be readily understood, a more particular description of the subject matter briefly described above will be rendered by reference to specific embodiments that are illustrated in the appended drawings. Understanding that these drawings depict only typical embodiments of the subject matter of the present disclosure and are not therefore to be considered to be limiting of its scope, the subject matter will be described and explained with additional specificity and detail through the use of the accompanying drawings, in which:

FIG. 1 is an isometric view of a trailer electrical connector, shown from a front of the trailer electrical connector, according to one or more examples of the present disclosure;

FIG. 2 is an isometric view of the trailer electrical connector of FIG. 1, shown from a rear of the trailer electrical connector, according to one or more examples of the present disclosure;

FIG. 3 is a top plan view of the trailer electrical connector of FIG. 1, according to one or more examples of the present disclosure;

FIG. 4 is a bottom plan view of the trailer electrical connector of FIG. 1 according to one or more examples of the present disclosure;

FIG. 5 is an isometric side view of a trailer electrical connector of FIG. 1, shown from a first side of the trailer electrical connector, according to one or more examples of the present disclosure;

FIG. 6 is an isometric side view of a trailer electrical connector of FIG. 1, shown from a second side of the trailer electrical connector, according to one or more examples of the present disclosure;

FIG. 7 is an isometric view of the trailer electrical connector of FIG. 1, shown from a top view of the front end of trailer electrical connector, according to one or more examples of the present disclosure;

FIG. 8 is a front elevation view of the trailer electrical connector of FIG. 1, according to one or more examples of the present disclosure;

FIG. 9 is an isometric view of the trailer electrical connector of FIG. 1, shown with a magnet removed from a receptacle of a housing of the trailer electrical connector, according to one or more examples of the present disclosure;

FIG. 10 is an isometric view of a trailer electrical connector of FIG. 1, shown from a front of the trailer electrical connector with a magnet removed from a receptacle of a housing of the trailer electrical connector, according to one or more examples of the present disclosure;

FIG. 11 is a cross-sectional side elevation view of a trailer electrical connector of FIG. 1, taken along the line 1-1 of FIG. 4, according to one or more examples of the present disclosure;

FIG. 12A is a housing of a trailer electrical connector, according to one or more examples of the present disclosure;

FIG. 12B is a housing of a trailer electrical connector, according to one or more examples of the present disclosure;

FIG. 12C is a housing of a trailer electrical connector, according to one or more examples of the present disclosure;

FIG. 13 is a perspective view of an electrical connector system, showing a trailer electrical connector of the system engaged with a vehicle electrical connector of the system, according to one or more examples of the present disclosure;

FIG. 14 is a side view of an electrical connector system, showing a trailer electrical connector of the system engaged with a vehicle electrical connector of the system, according to one or more examples of the present disclosure;

FIG. 15 is a side elevation view of the trailer electrical connector, shown selectively magnetically attached to a trailer frame, according to one or more examples of the present disclosure;

FIG. 16 is a front view of a trailer electrical connector, according to one or more examples of the present disclosure;

FIG. 17 is side view of a trailer electrical connector of FIG. 16, according to one or more examples of the present disclosure;

FIG. 18 is a front view of a trailer electrical connector, according to one or more examples of the present disclosure;

FIG. 19 is side view of a trailer electrical connector of FIG. 18, according to one or more examples of the present disclosure;

FIG. 20 is a front view of a trailer electrical connector, according to one or more examples of the present disclosure;

FIG. 21 is side view of a trailer electrical connector of FIG. 20, according to one or more examples of the present disclosure;

FIG. 22 is a front view of a trailer electrical connector, according to one or more examples of the present disclosure;

FIG. 23 is side view of a trailer electrical connector of FIG. 22, according to one or more examples of the present disclosure;

FIG. 24A is a perspective view of a first attachment for the receptacle of the trailer electrical connector of FIGS. 1, 18, and 22, according to one or more examples of the present disclosure;

FIG. 24B is a perspective view of a second attachment for the receptacle of the trailer electrical connector of FIGS. 1, 18, and 22, according to one or more examples of the present disclosure; and

FIG. 24C is a perspective view of a third attachment for the receptacle of the trailer electrical connector of FIGS. 1, 18, and 22, according to one or more examples of the present disclosure.

### DETAILED DESCRIPTION

Reference throughout this specification to “one example,” “an example,” or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more embodiments of the subject matter of the present disclosure, however, absent an express correlation to indicate otherwise, an implementation may be associated with one or more embodiments.

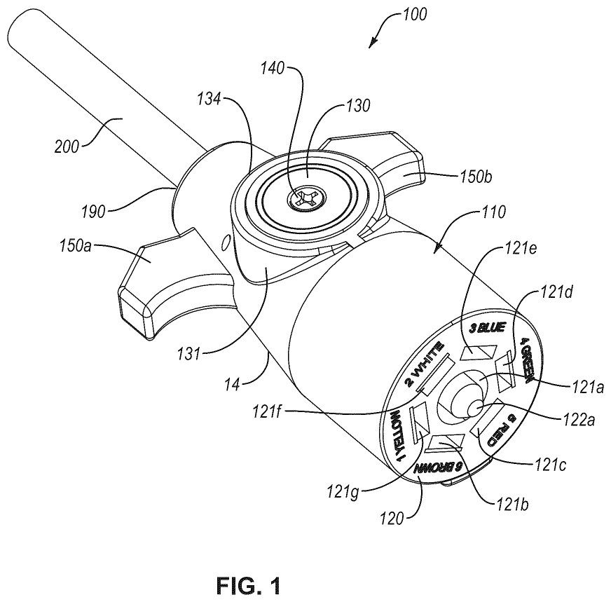

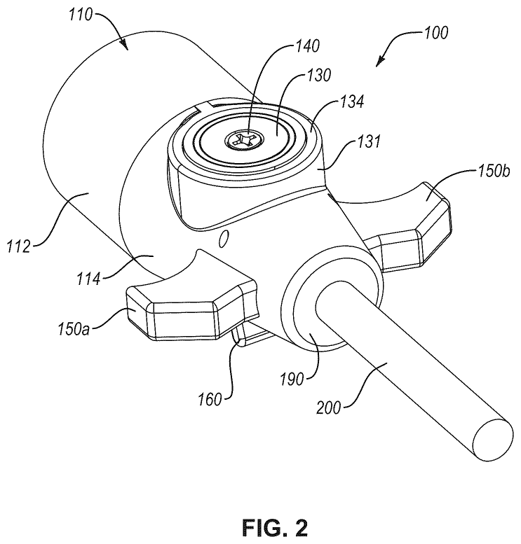

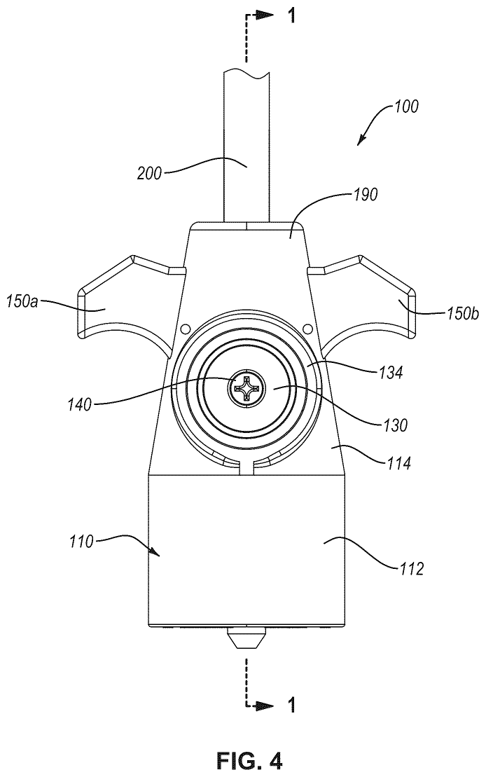

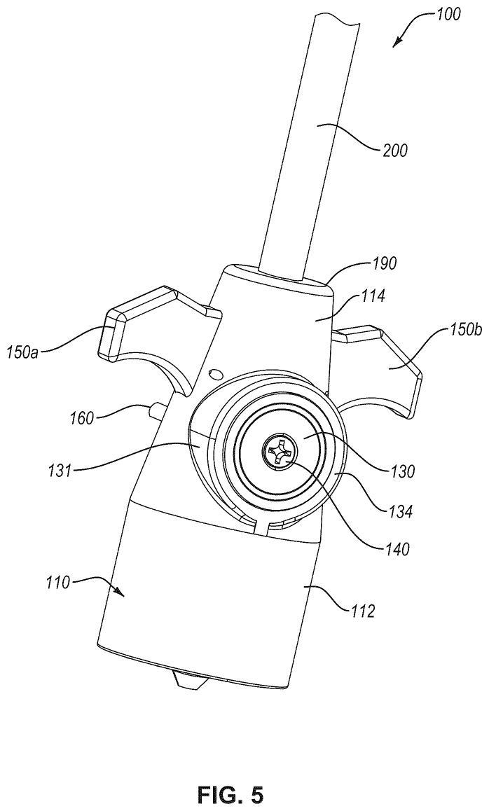

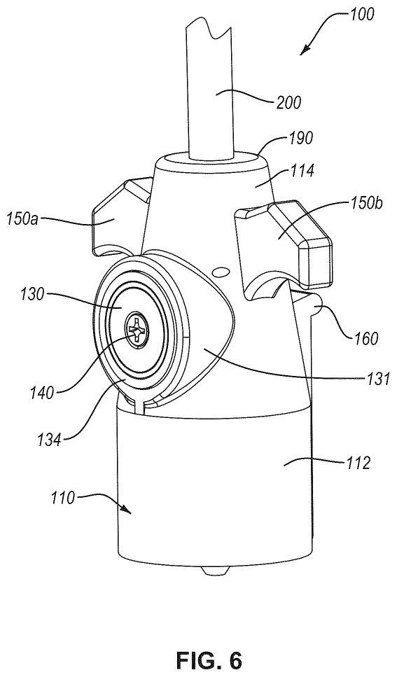

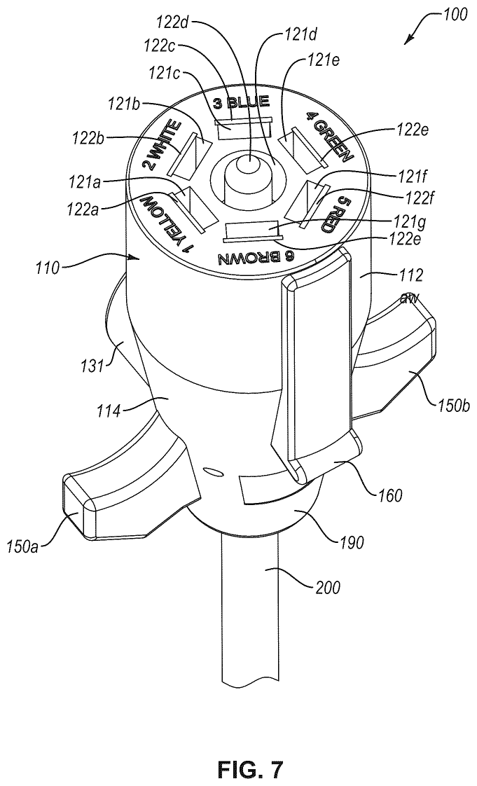

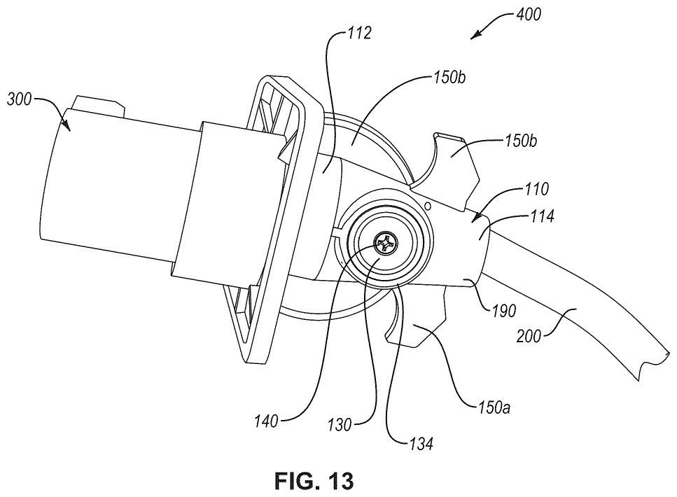

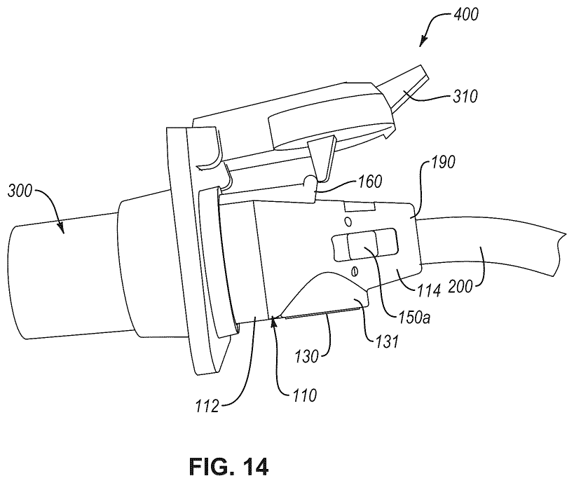

Referring to FIGS. 1-7, according to one example, a trailer electrical connector 100 includes a housing 110, electrical connections 122a-g, a magnet 130, and a cord 200. The housing 110 includes an interface end 120 and a cord end 190. The interface end 120 is configured to mate with a vehicle electrical connector 300 (see, e.g., FIGS. 13-14). Accordingly, in certain examples, the interface end 120 includes a pattern of engagement features 121a-g each configured to receive a corresponding one of a plurality of engagement features of the vehicle electrical connector 300, which are arranged in a pattern corresponding with that of the engagement features 121a-g. In the illustrated example, the engagement features 121a-g are apertures, which are configured to receive prongs of the vehicle electrical connector 300. However, in other examples, the engagement features 121a-g can be prongs configured to be inserted into corresponding apertures of the vehicle electrical connector 300. The cord end 190 of the housing 110 is configured to receive and retain the cord 200. The housing has a length 180 that extends from the interface end 120 to the cord end 190.

The housing may be portioned into a front section 112 and a rear section 114. The individual lengths of the front section 112 and the rear section 114 are combined to equal the overall length 180 of the housing 110. The front section 112 includes the interface end 120, the engagement features 121a-g, and the electrical connections 122a-g. The front section 112 may be any length based on the configuration of the corresponding apertures of the vehicle electrical connector 300. In some examples, as shown in FIGS. 1-15, the front section 120 is cylindrical, or tubular, and the rear section 114 tapers from the front section 112 to the cord end 190 where the housing 110 connects to the cord 200. In other words, in some examples, the front section 112 has a constant outer dimension (e.g., diameter) along its length, and the rear section 114 has a variable outer dimension (e.g., diameter) along its length, such as one that decreases in a direction away from the front section 112. In certain examples, the rear section 114 has a circular cross-sectional shape, such that the rear section 114 has a conical shape. In other examples, the rear section 114 has flat faces that define a polygonal cross-sectional shape, such that the rear section has a pyramid shape. Accordingly, in certain examples, the front section 112 and/or the rear section 114 can have any of various cross-sectional shapes, other than circular, which can correspond with or not correspond with the cross-sectional shape of a receptacle of the vehicle electrical connector 300.

The rear section 114 includes the magnet receptacle 131, extrusions 150a-b, and the cord end 190. The rear section may vary in length depending on the magnet receptacle 131 and the extrusions 150a-b.

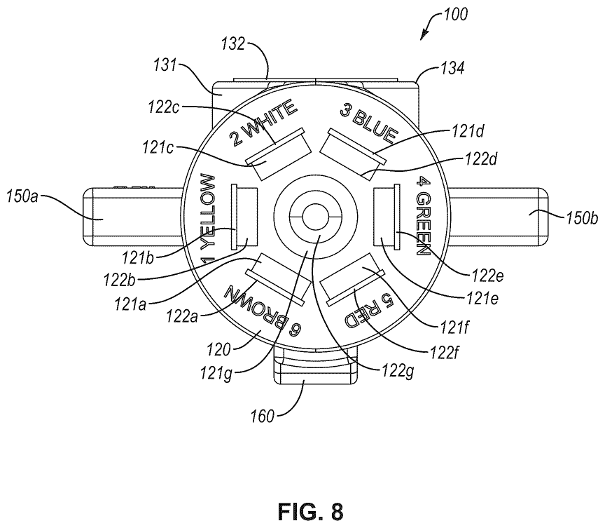

As shown in FIGS. 1-15, the housing may have multiple extrusions 150a-b (e.g., handles). In one example, the housing includes two extrusions 150a-b extending from opposing sides of the rear section 114. The extrusions 150a-b extend perpendicularly away from an exterior surface of the rear section 114, e.g., perpendicularly away from a central axis of the connector. Alternatively, extrusions 150a-b have a external planar face which is parallel to the mounting surface 132 of the magnet 130, as shown in FIG. 8. These grip extrusions 150a-b are shaped in such a way to provide a user with an increased grip for removal and/or insertion of the trailer electrical connector. In the example shown in FIGS. 1-15, the extrusions 150a-b are shaped to form graspable wings on either side of the housing 110 to be grasped by a user during the disengagement and/or engagement of the trailer electrical connector 100 and the vehicle electrical connector 300. As shown, the extrusions 150a-b extend from the exterior surface of the tapering portion of the rear section 114 of the housing. In other examples, the extrusions 150a-b are located on, or form part of, the front section 112 and are closer to the interface end 120 of the connector. In another example, the extrusions 150a-b may consist of a series of ridges to increase the surface area gripped by the user. As shown in FIGS. 1-15, the extrusions 150a-b have a curved finger-gripping indentation which faces towards the interface end 120. Alternatively, the extrusions 150a-b may be circular having a large central hole in which a user may insert one or more fingers in order to grasp and remove the connector.

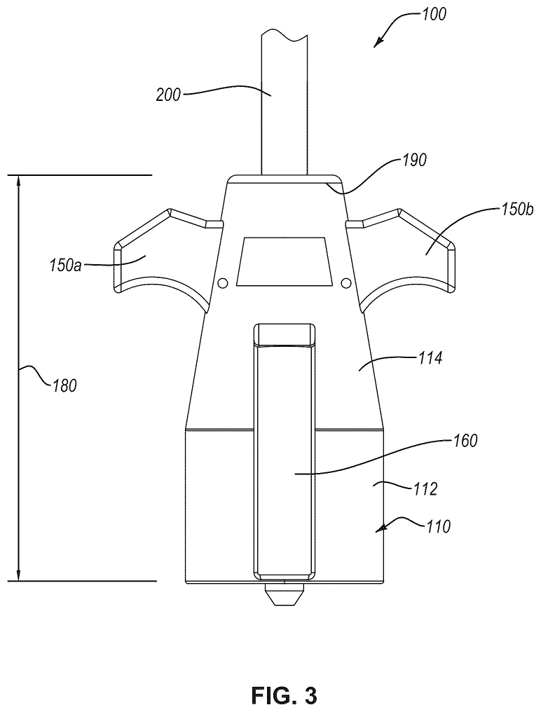

Also shown in FIGS. 3, 5, 6-9, 11, and 14, the housing 110 can include a resting notch 160 or guide tab for a vehicle connector cover 310 to rest on or engage with when the trailer electrical connector 100 and the vehicle electrical connector 300 are engaged. The resting notch 160 may also act as a guide or alignment key for guiding the trailer electrical connector 100 (e.g., plug) into the vehicle electrical connector 300 (e.g., socket) at a proper orientation relative to the vehicle electrical connector 300. In some examples, the housing 110 may include both the grip extrusions 150a-b and the resting notch 160. In an alternative embodiment, the housing 100 may include a single feature that functions as both a grip extrusion 150 and a resting notch 160.

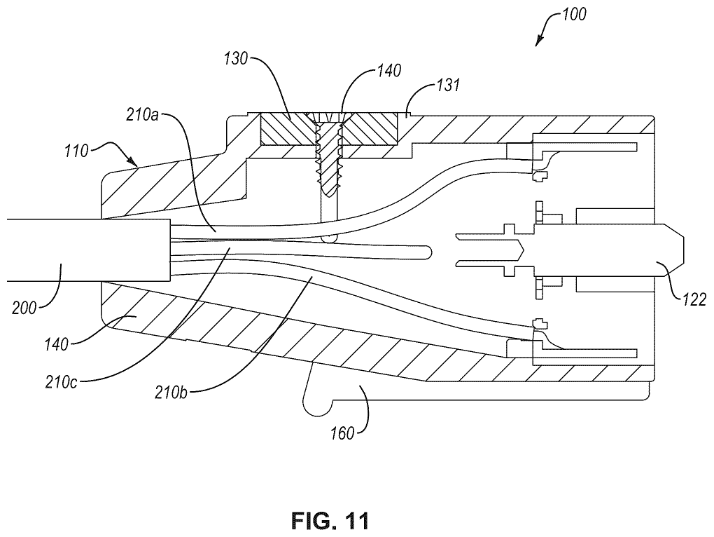

The housing 110 houses and protects the electrical connections 122a-g, which are coupled with the engagement features 121a-g so that when the engagement features 121a-g of the housing 110 are mated with the engagement features of the vehicle electrical connector 300, electrical connectors of the vehicle electrical connector 300 contact and establish electrical connection with corresponding ones of the electrical connections 122a-g. Each one of the electrical connections 122a-g is electrically connected with a corresponding one or more electrical wires 210a-g of the cord 200. For example, as shown in FIG. 11, electrical wire 210a is connected to the electrical connection 122a and corresponds to engagement feature 121a.

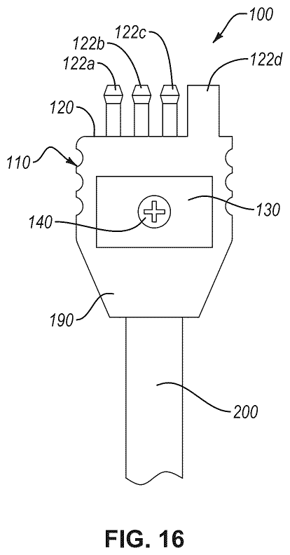

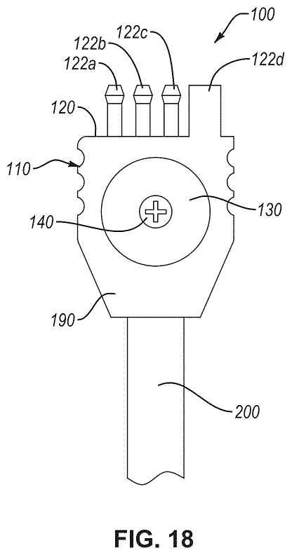

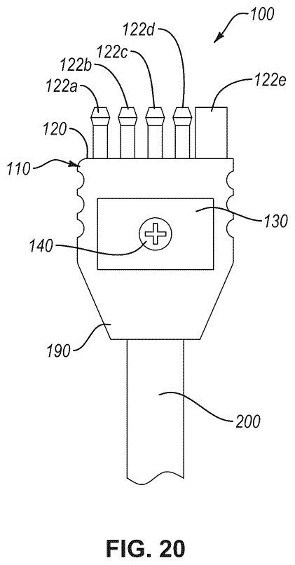

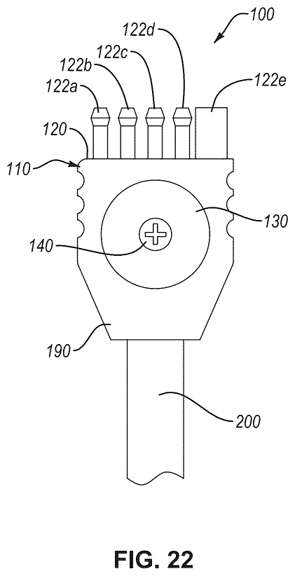

The housing 110 additionally includes a magnet receptacle 131 shaped to hold a magnet 130. The receptacle 131 may vary in shape and size based on the shape and size of the magnet 130. In one example, the receptacle 131 and the magnet 130 are circular shaped, such as shown in FIGS. 1-15, 18, and 22. However, in other examples, the receptacle 131 and the magnet 130 are polygonal shaped (e.g., rectangular or square), such as shown in FIGS. 16 and 20. The location of magnet receptacle 131 will vary based on housing 110 shape and electrical engagement features 121a-g. In the example shown in FIGS. 1-7, the magnet receptacle 131 is located near the midpoint of the housing length 180. The magnet receptacle 131 is further located in approximately equidistance between the extrusions 150a and 150b on the back section of the housing 110. The central location will assist a user in providing equal force on the electrical connector 100 when disengaging from storage or removing from the corresponding vehicle connector.

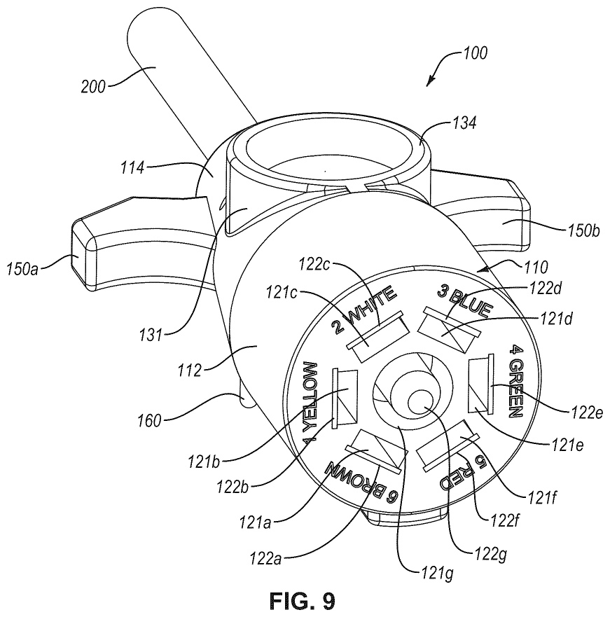

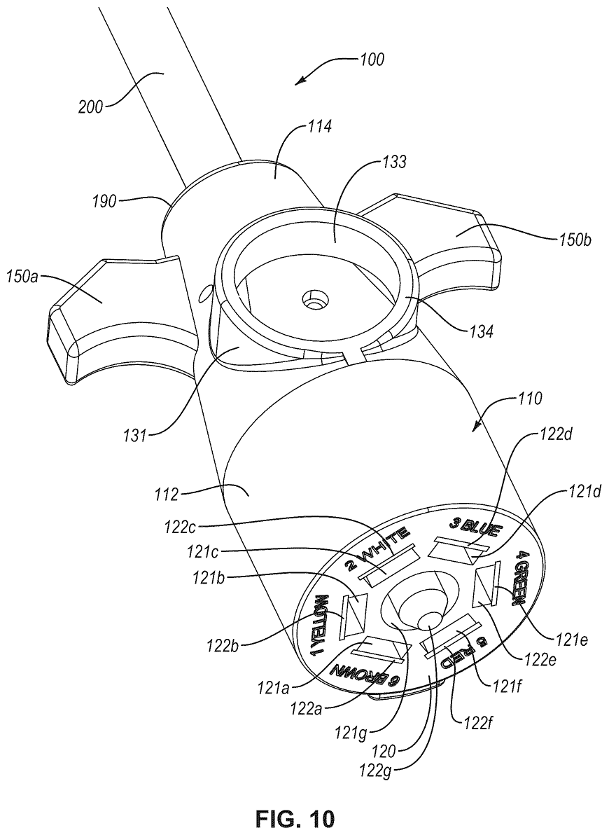

As shown in FIGS. 1-7, the magnet 130 is seated within the magnet receptacle 131 so that a mounting surface 132 of the magnet 130 is exposed and faces away from the housing 110. In some examples, as shown FIGS. 9 and 10, the magnet receptacle 131 is defined within a boss 133 protruding from an exterior surface of the back section of the housing 110. As shown in FIGS. 9 and 10, the magnet receptacle 131 extends from the tapering portion of the rear section 114 of the connector. In some examples, the magnet receptacle 131 extends from the tapered portion having a height such that an outer rim 133 of the magnet receptacle 131 is substantially flush with an exterior surface of the front section 112 of the housing 110 of the connector. In some examples, the magnet 130 extends past the magnet receptacle 131 so that a mounting surface 132 (i.e., exposed surface) of the magnet 130, which is parallel to the central axis of the connector, is proud of the outer rim 133, as shown in FIGS. 8 and 11. In other examples, the mounting surface 132 of the magnet 130 is flush with the magnet receptacle 131 and the outer rim 133. The mounting surface 132 is configured to magnetically attach to a metal portion of a trailer frame corresponding with the electrical connector 100. In another example, the mounting surface 132 magnetically engages a magnet, formed in or attached to the trailer, which has an opposite polar charge of the mounting surface 132 of the magnet 130. The polar opposite connection increases the strength of the magnetic connection between the trailer electrical connection 100 and the trailer frame so that the electrical connector 100 cannot be accidentally disengaged from a storage location.

The magnet 130 is attached to the housing 110 at least partially within the receptacle 131 using any of various methods. In one example, the magnet 130 may be fastened to the receptacle by at least one of the following: a screw 140, nail, or rivet. In an alternative example, the magnet 130 may be attached by a chemical bonding or adhesion techniques, such as via an adhesive or glue. In another example, the magnet 130 may be retained in place in the housing as the housing is molded during a molding process. In yet another example, the magnet 130 is selectively secured within the receptacle 131 by at least one resiliently flexible tab or rib formed in or around the receptacle 131.

As shown, in some examples, the magnet 130 is attached to the housing 110 within the receptacle 131 by a screw 140. The screw 140 can be unfastened to remove the magnet 130 from the housing 110 and the receptacle 131. The magnet 130 can then be interchanged with another magnet or be inserted back into the receptacle 131. The magnet may be removed for a number of reasons such as: to change the strength of the magnet; to replace a damaged magnet; to clean the magnet; and to clean the receptacle, to name a few.

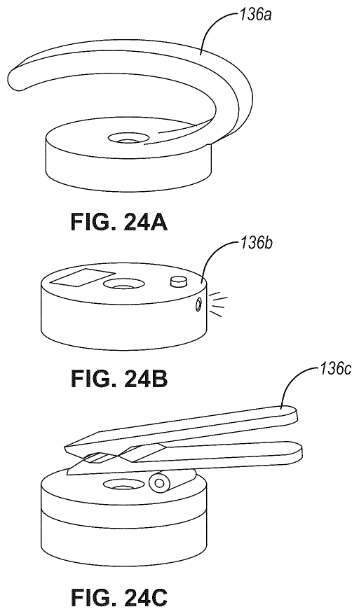

As shown in FIGS. 24A-C, respectively, trailer engagement attachments other than a magnet, such as a hook 136a, a light 136b, or a clip 136c, may be interchangeably attached to and within the receptacle 131. In one example, the magnet 130 may be interchanged with an alternative trailer engagement attachment by replacing the magnet 130 with a desired one of the one or more trailer engagement attachments. In another example, a trailer engagement attachment, other than the magnet, can encase the receptacle 131 and internally connect to the magnet 130.

In another example, as mentioned, the magnet 130 is secured within the receptacle 131 by at least one tab or rib. The tab can have a resiliently flexible portion that resiliently flexes to insert the magnet 130 into and returns to its original shape to retain the magnet 130 within the receptacle 131. The tab or rib can resiliently flex when the magnet is being removed and return to its original shape when the magnet is removed. The housing 110 can include a single tab or rib that partially overs the receptacle 131. In yet some examples, the housing 110 has a series of tabs arranged along the outer edge of the receptacle 131. As mentioned, whether a single tab or rib, or multiple tabs or ribs, the tab(s) or rib(s) help to removably secure the magnet 130 and enable selective removal of the magnet 130 for replacement or cleaning.

The magnet 130 is located within the housing 110 such that it does not affect the wires. Magnets with a strong magnetic field will disrupt the flow of electricity in cords. Thus, the magnet 130 is chosen to have a strength such that it would not easily disengage from a metal frame without user intervention but not so strong as to disrupt the electricity of the cord. In one example, the magnet receptacle 131 may be surrounded by insulating materials. These materials interfere with the magnetic field to lessen the effects on the electricity of the wires 210a-g within the cord 200. In an alternative example, the magnet receptacle 131 may be located at a distance such that the magnetic field has less strength near the wires 210a-g of the cord 200. In another example, the magnet receptacle 131 is located such that the magnetic field has less strength and the receptacle 131 has insulating materials surrounding it.

As shown in FIG. 11, the magnet receptacle 131 is positioned to limit the effect of the magnetic field on the wires 210a-g within the cord 200. Additionally, the magnet receptacle 131 has a layer of insulating material 134 to further lessen the magnetic field of the magnet 130 within the internal cavity 170 of the housing 110.

Referring to FIGS. 13 and 14, the trailer electrical connector 100 forms part of an electrical connection assembly 400 that further includes a vehicle electrical connector 300. In this example, the trailer electrical connector 100 has an extrusion 160 which provides a resting place for the vehicle connector cover 310 while the trailer electrical connector and the vehicle electrical connector 300 are engaged to form the electrical connection assembly.

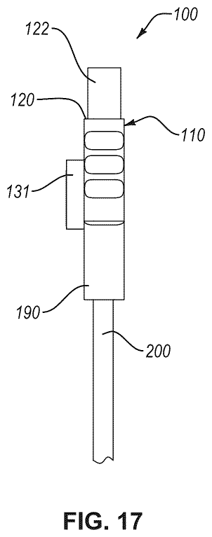

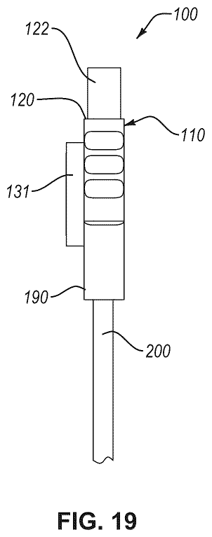

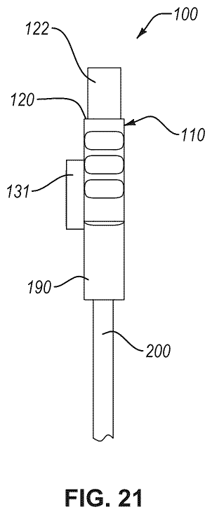

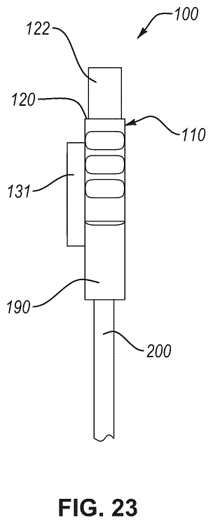

According to one example, as shown in FIGS. 1-18, the interface end 120 of the trailer electrical connector 100 is adapted to receive a 7-prong vehicle connector 300. In such examples, the housing has a generally circular-shaped cross-section. In another example, as shown in FIGS. 16-19, the interface end 120 of the trailer electrical connector 100 is adapted to mate with a 4-prong vehicle connector 300. In another example, as shown in FIGS. 20-23, the interface end 120 of the trailer electrical connector 100 is adapted to mate with a 5-prong vehicle connector 300. In these latter two examples, the housing has a flatter shape or non-round cross-sectional shape, such as a rectangular-shaped cross-section.

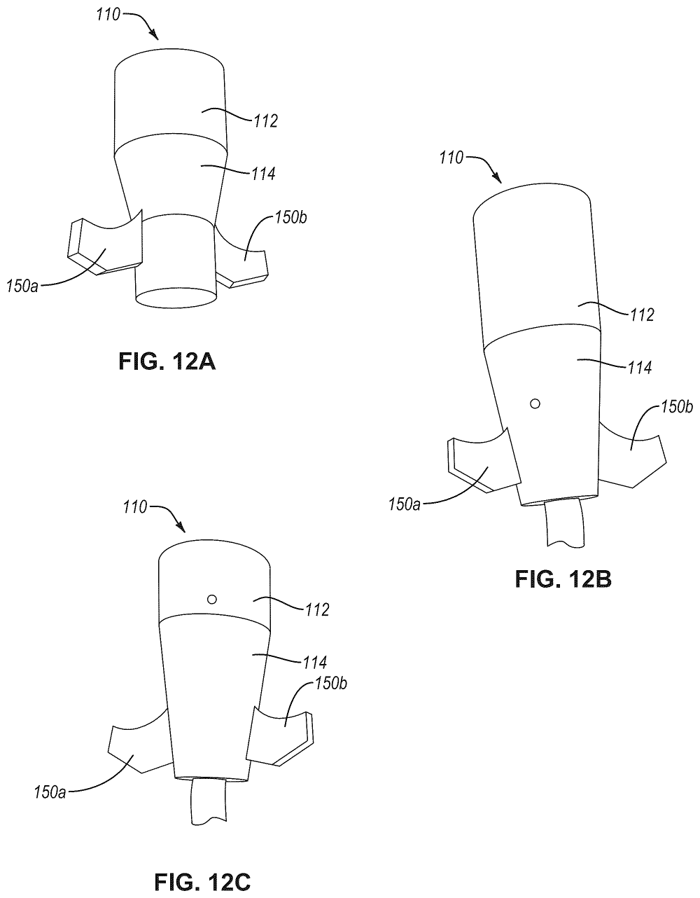

Additionally, the housing may be manufactured to have a range of lengths and sizes. As shown in FIGS. 12A-12C, the length of the housing 110, from the plug face 120 to the beginning of the cord 200, can vary. In one example, the rear section may be a consistent taper. In another example, the rear section has a taper to the grip extrusions 150a-b then remains a consistent cylindrical shape, as shown by FIG. 12A. Alternatively, the rear section of the housing may have a relatively long taper to the cord 200 as shown by FIG. 12C, or a relatively short taper as shown by FIG. 12B.

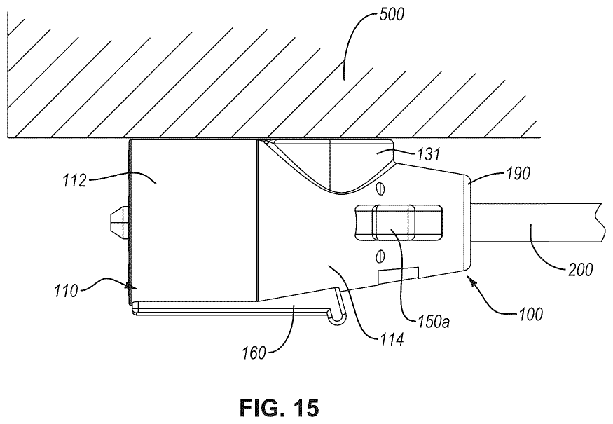

Also disclosed is a method for storing a trailer receiving plug. The method includes removing a trailer receiving plug 100 from a vehicle prong plug 300 and attaching the trailer receiving plug 100 to a metal frame 500 via a magnet 130 attached to the trailer receiving plug 100. The trailer receiving plug 100 may be connected to any metal on the trailer frame 500, as shown in FIG. 15. This method creates a safe and secure storage for the trailer receiving plug when not in use.

As mentioned above, an example system for an electrical connector assembly 400 is described. The system includes a vehicle electrical connector 300 and a trailer electrical connector 100. The trailer electrical connector 100 includes a housing 110, electrical connectors 121a-g, a magnet 130, and a cord 200. The trailer electrical connector housing 110 may be any of the examples described above.

In the above description, certain terms may be used such as “receiving,” “inserting,” “attaching,” “connecting,” and the like. These terms are used, where applicable, to provide some clarity of relationships. But, these terms are not intended to imply absolute relations. Rather, these terms may be interchangeable with one another.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

The subject matter of the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A trailer electrical connector comprising:
a housing comprising:
a front section defining an electrical interface end of the housing;
a rear section defining a cord engagement end of the housing and extending from the front section, wherein the electrical interface end of the housing is smaller than the cord engagement end of the housing, and wherein the rear section comprises a tapering portion that tapers away from the front section toward the cord engagement end; and
a receptacle formed in an external surface of the tapering portion of the rear section of the housing;
a magnet within and attached to the receptacle such that the magnet does not move relative to the housing;
a plurality of electrical connections located at the electrical interface end of the housing; and
a cord attached to the cord engagement end of the housing.

2. The trailer electrical connector of claim 1, wherein the receptacle and the magnet have a circular cross-sectional shape.

3. The trailer electrical connector of claim 1, wherein the housing further comprises a guide tab protruding from the external surface of the tapering portion of the rear section of the housing and from an external surface of the front section of the housing.

4. The trailer electrical connector of claim 1, wherein the electrical interface end is adapted to receive a 7-prong vehicle electrical connector.

5. The trailer electrical connector of claim 1, wherein the electrical interface end is adapted to receive one of a 4-prong vehicle electrical connector or a 5-prong vehicle electrical connector.

6. The trailer electrical connector of claim 1, wherein a height of the receptacle, at a location closest to the electrical interface end of the housing, is less than a height of the receptacle, at a location closest to the cord engagement end of the housing.

7. The trailer electrical connector of claim 1, wherein the housing further comprises at least two handles located on opposing sides of the housing.

8. The trailer electrical connector of claim 7, wherein the at least two handles protrude perpendicular to a central axis and are parallel to a mounting surface of the magnet.

9. The trailer electrical connector of claim 8, wherein a portion of each one of the at least two handles overlaps with another portion of the corresponding one of the at least two handles along a plane perpendicular to a central axis of the trailer electrical connector.

10. The trailer electrical connector of claim 1, wherein the magnet comprises a mounting surface that is planar and is proud relative to the receptacle.

11. The trailer electrical connector of claim 1, wherein:
the receptacle comprises an outer rim; and
the outer rim is substantially flush with an exterior surface of the front section.

12. The trailer electrical connector of claim 11, wherein the housing further comprises at least two handles located on opposing sides of the housing protruding from the tapering rear portion of the housing.

13. The trailer electrical connector of claim 12, wherein the handles lie within a first plane that is parallel to a planar mounting surface of the magnet.

14. The trailer electrical connector of claim 1, wherein the housing further comprises at least one set of ridges along the body of the housing.

15. The trailer electrical connector of claim 1, wherein the magnet comprises a planar exterior surface flush with the receptacle.

16. The trailer electrical connector of claim 1, wherein:
the magnet is selectively removable from the receptacle; and
any one of a plurality of trailer engagement couplings is interchangeable with the magnet and selectively attachable to and within the receptacle.

17. A method of storing a trailer electrical connector comprising:
disconnecting a trailer electrical connector of a trailer from a vehicle electrical connector of a vehicle; and
selectively magnetically attaching a magnet of the trailer electrical connector to a connector portion of the trailer.

18. The method of storing a trailer electrical connector of claim 17, wherein the connector portion is made of metal.

19. The method of storing a trailer electrical connector of claim 17, wherein the connector portion comprises a magnet having a polarity that is opposite the polarity of the magnet of the trailer electrical connector.

20. An electrical connector system comprising:
a vehicle electrical connector; and
a trailer electrical connector comprising:
a housing comprising:
a front section defining an electrical interface end of the housing;
a rear section defining a cord engagement end of the housing and extending from the front section, wherein the electrical interface end of the housing is smaller than cord engagement end of the housing, and wherein the rear section comprises a tapering portion that tapers away from the front section toward the cord engagement end; and
a receptacle formed in an external surface of the tapering portion of the rear section of the housing;
a magnet within and attached to the receptacle such that the magnet does not move relative to the housing;
a plurality of electrical connections located at the electrical interface end of the housing; and
a cord attached to the cord engagement end of the housing.
